(19) United States
(12) Patent Application Publication
(10) Pub. No.: US 2026/0297759 A1
(43) Pub. Date: Oct. 1, 2026

(54) CATHODIC PROTECTION SYSTEM AND METHOD FOR OIL AND GAS HEATER TREATER VESSEL

(71) Applicant: Derek Allen, Midland, TX (US)

(72) Inventor: Derek Allen, Midland, TX (US)

(21) Appl. No.: 19/097,076

(22) Filed: Apr. 1, 2025

(51) Int. Cl. C23F 13/18; B01D 17/04; B01D 17/12; C23F 13/14; C23F 13/22; E21B 43/34

(52) U.S. Cl. CPC C23F 13/18; B01D 17/042; B01D 17/12; C23F 13/14; C23F 13/22; E21B 43/34

(57) ABSTRACT

A cathodic protection system for a heater treater vessel that includes a consumable assembly removably coupled to an anode port of the vessel and a sensor assembly coupled to a sensor port of the vessel. The consumable assembly includes an anode assembly and an anode receiver assembly. The anode assembly includes a metal rod and an anode comprised of a weaker metal than the metal rod. The anode receiver assembly includes a receiver portion and a ground member and the receiver portion is electrically connected to the ground member. The metal rod of the anode assembly is received in and electrically connected to the receiver portion. The ground member is electrically connected to the housing to provide an electrical grounding point. The metal rod and the anode are submerged within the water phase of the vessel to provide cathodic protection to the interior of the housing by completing an electrical circuit within the water phase of the vessel.

### FIELD OF THE INVENTION

The present invention relates generally to oil and gas heater treater vessels and more particularly to a cathodic protection system and method for oil and gas heater treater vessel.

### BACKGROUND OF THE INVENTION

Oil and gas heater treater vessels are known and utilize heat and mechanical separation devices to facilitate the separation of oil-water emulsions before transporting dry oil through pipelines. By applying heat to oil well stream emulsions, the vessel separates water, oil, and gas in a three-phase separator. The vessel may be implemented in vertical or horizontal The vessels are filled to a specified level with saltwater. Corrosion may occur because of an electrochemical reaction where the metal of the vessel (anode) loses electrons and corrodes, while oxygen or other substances (cathode) gain electrons. The present invention provides an anode to be sacrificed to provide cathodic protection to the material of the vessel (e.g., steel). However, once the anode is sacrificed, the material of the vessel may begin corroding. Therefore, a monitoring system that monitors the anode may also be helpful.

The background description disclosed anywhere in this patent application includes information that may be useful in understanding the present invention. It is not an admission that any of the information provided herein is prior art or relevant to the presently claimed invention, or that any publication specifically or implicitly referenced is prior art.

### SUMMARY OF THE PREFERRED EMBODIMENTS

In accordance with an aspect of the present invention there is provided a cathodic protection system for a heater treater vessel. The heater treater vessel includes a housing, a heating element, and an anode port. The vessel is configured to be supplied with crude oil emulsions for treatment by the vessel. The treatment includes applying heat from the heating element causing separation of the emulsion into oil, gas, and water phases, such that electrical current is generated within the water phase of the vessel. The system includes a consumable assembly removably coupled to the anode port. The consumable assembly includes an anode assembly and an anode receiver assembly. The anode assembly includes a metal rod and an anode comprised of a weaker metal than the metal rod and the anode is in contact with the metal rod. The anode receiver assembly includes a receiver portion and a ground member. The receiver portion is electrically connected to the ground member. The metal rod of the anode assembly is received in and electrically connected to the receiver portion. The ground member is electrically connected to the housing to provide an electrical grounding point. The metal rod and the anode are submerged within the water phase of the vessel to provide cathodic protection to the interior of the housing by completing an electrical circuit within the water phase of the vessel.

The cathodic protection system may include a sensor assembly coupled to a sensor port in the vessel. The sensor assembly includes a sensing point, an extension shaft, an electrode on the extension shaft, an isolation unit configured to electrically isolate the sensor assembly from the housing, a first contact member positioned on an electrode side of the isolation unit and a second contact member positioned on a ground side of the isolation unit. The electrode and the sensing point are submerged in the water phase of the vessel. When a measured voltage between the electrode and the anode exceeds a predetermined threshold, the anode assembly is removed from the anode receiver assembly and replaced with a second anode assembly.

The first contact member may include a threaded opening extending axially therethrough. The extension member may be externally threaded and extend through the first contact member. The extension member may also extend through the second contact member. In another embodiment, these components may be unitary. The first contact member may include a first threaded portion that is connected to the sensor port (e.g., connected to a sleeve that communicates the interior and exterior of the vessel.

The receiver portion may include a receiver opening defined therein and the metal rod of the anode assembly may be received in the receiver opening. The receiver portion may include a securing opening defined therein that extends in a direction generally perpendicular to the receiver opening. A threaded fastener may be received in the securing opening and against the metal rod of the anode assembly to secure the anode assembly in position.

In accordance with another aspect of the present invention there is provided a method of cathodically protecting a heater treater vessel that includes a housing. The method includes associating a consumable assembly with the housing, and associating a sensor assembly with the housing. The consumable assembly includes an anode assembly and an anode receiver assembly. The anode assembly includes a metal rod and an anode comprised of a weaker metal than the metal rod. The anode is in contact with the metal rod. The anode receiver assembly includes a receiver portion and a ground member, the receiver portion is electrically connected to the ground member, the metal rod of the anode assembly is received in and electrically connected to the receiver portion, the ground member is electrically connected to the housing to provide an electrical grounding point, and wherein the metal rod and the anode are submerged within a water phase of the vessel. The sensor assembly includes an electrode submerged within the water phase of the vessel, and the sensor assembly is electrically isolated from the housing. The method also includes measuring a voltage between the electrode of the sensor assembly and the anode of the consumable assembly. If the measured voltage exceeds a predetermined threshold, the anode assembly is removed from the anode receiver assembly and replaced with a second anode assembly. The method may include measuring the voltage at predetermined time intervals.

In accordance with another aspect of the present invention there is provided a consumable assembly for use in a cathodic protection system associated with a heater treater vessel. The consumable assembly includes an anode receiver assembly that includes a receiver portion and a ground member, and an anode receiver assembly. The receiver portion is electrically connected to the ground member. The anode assembly includes a metal rod and an anode comprised of a weaker metal than the metal rod. The anode is in contact with the metal rod. The metal rod of the anode assembly is received in and electrically connected to the receiver portion.

The ground member may be configured to be secured in a victaulic fitting. The ground member may include a threaded opening defined therein and a threaded rod may be received in the threaded opening. The threaded rod may extend co-axially with the metal rod of the anode assembly. The ground member may be configured to be secured in a flange fitting. The receiver portion may include a receiver opening defined therein and the metal rod of the anode assembly may be received in the receiver opening.

Cathodic protection may turn the entire metal structure (like the heater treater vessel) into a cathode, where no corrosion occurs because it's receiving electrons rather than losing them. The present invention may include a sacrificial anode system, which involves installing an anode made of a more reactive metal than the vessel's steel (like aluminum, zinc, or magnesium) inside the vessel. The anode corrodes preferentially, sacrificing itself to protect the steel. The present invention also includes an anode receiver assembly that is configured to hold or secure the sacrificial anode within the vessel interior and electrically connect the anode receiver assembly to the vessel to provide a ground for the material of the consumable anode.

The present invention also includes a system for monitoring the anode to determine how it is performing and when it is time to replace the anode because it has been sacrificed or consumed to a predetermined point or amount. The monitoring system may include a reference electrode assembly, such as a zinc electrode. The electrode or sensor assembly may include an isolation unit (which isolates the electrode assembly from the vessel) so that the zinc electrode or the like does not become an anode. The voltage reading across a portion of the electrode assembly in the vessel interior and a portion exterior of the vessel provides information regarding the status the anode. The current reading within the water phase helps provide the monitoring information to determine if the anode material has been sacrificed to the point where it needs to be changed.

In a preferred embodiment, the anode receiver assembly may replace the plastic cap on an existing sleeve or tube on the vessel and may be secured to the vessel using a flange fitting or victaulic fitting or the like. For example, many heater treaters may include a fire tube or other tube extending outwardly therefrom that include flanges where the anode receiver assembly may be mounted or secured.

The anode assembly may include an aluminum portion with a metal (e.g., steel) rod in the middle. The steel rod fits into the steel receiver of the anode receiver assembly. The metal of the receiver touches the vessel at some point. The anode receiver assembly may include an allthread bolt.

In use of the heater treater vessel, corrosion happens from electrical current within the salt water or other fluid therein. Corrosion may be rust from the steel of the vessel wall. It will be appreciated that electrical current attacks the weaker metal. Therefore, cathodic protection provides a sacrificial material (e.g., aluminum) that sacrifices itself and may offset the electrical current inside the vessel to be more negative than positive to keep a more stable environment. To work, there must be an electrolyte, a source (aluminum), and grounding, to complete the circuit. In the prior art anodes, there is an issue with grounding as the heater treater may include a plastic cap which requires a wire to ground. It will be appreciated that aluminum is the weaker metal (compared to steel) and as the current increases, the aluminum “takes the hit” or is sacrificed and slows down the corrosive process. However, the anode must be a part of a complete circuit to operate or sacrifice properly. The anode may be made of any sacrificial or consumable material and is preferably aluminum or principally aluminum. Table 1 shows non-limiting examples of the chemical composition of sacrificial anode material.

TABLE 1
Chemical Composition of Anode Material

| | Chemical Composition (%) | | | | | | | |
|---|---|---|---|---|---|---|---|---|
| | Si | Fe | Cu | Zn | In | Ti | Others | Al |
| NO. | ≤0.10 | ≤0.10 | ≤0.006 | 3.0-6.0 | 0.01-0.02 | ≤0.025 | ≤0.02 | Balance |
| 1 | 0.0368 | 0.0808 | 0.0014 | 3.6328 | 0.0114 | 0.0027 | ≤0.02 | Balance |
| 2 | 0.0418 | 0.0907 | 0.0007 | 3.9995 | 0.0116 | 0.0035 | ≤0.02 | Balance |
| 3 | 0.0455 | 0.0928 | 0.0008 | 3.4957 | 0.0118 | 0.0027 | ≤0.02 | Balance |
| 4 | 0.0363 | 0.0765 | 0.0014 | 3.9382 | 0.0147 | 0.0058 | ≤0.02 | Balance |
| 5 | 0.0463 | 0.0837 | 0.0015 | 3.9097 | 0.0121 | 0.0086 | ≤0.02 | Balance |

The receiver or anode receiver assembly provides a self-grounding mechanism by the metal touching the vessel's steel as opposed to separately run ground wires to the plastic cap assembly that attach to the end of the metal rod (i.e., the aluminum encloses a carbon steel rod that extends to the outside of the vessel and makes an electrical ground connection).

The monitor or sensor assembly may be electrically isolated by a rubber gasket in the middle of the isolation unit (the plastic/rubber pieces that fit together). The monitor or sensor assembly may be used for periodic or on demand testing by measuring voltage across the two couplers (e.g., ¾ inch couplers). In use, a “negative and stable” voltage is desired. For example, with zinc as the reference metal/electrode, if the sensor assembly reading is over 200 millivolts positive the vessel is not being protected and the anode has to be changed. It will be appreciated that the use of different metals as the reference metal will result in different voltage readings and predetermined thresholds where the anode needs to be changed. For example, a negative (cathodic) potential of at least 850 mV with the cathodic protection applied. This potential is measured with respect to a saturated copper/copper sulfate reference electrode contacting the electrolyte. Voltage drops other than those across the structure-to-electrolyte boundary must be considered for valid interpretation of this voltage measurement. NACE (National Association of Corrosion Engineers) standards, specifically NACE RP0169, often use a −850 mV criterion, measured against a saturated copper/copper sulfate reference electrode (CSE), to assess the adequacy of cathodic protection on buried or submerged metallic piping systems. As discussed above, such standards can be applied to or calculated for other reference electrode materials.

The sensor assembly may include a steel tip at the distal end thereof, and at the end of the zinc or other material. The steel tip end at the end of the zinc is the sensing point so a user can determine how well steel is doing in the environment, as discussed above. The present invention may include an “auto sensing” function using the sensor assembly and for determining the voltage. With this function, a user can automatically be alerted when the anode needs to be replaced. The sensor assembly can also be tested using a voltmeter across the positive and negative electrodes with the isolation unit therebetween.

In use, the anode and at least a portion of the metal rod of the anode assembly and the electrode member and at least a portion of the extension shaft of the sensor assembly are positioned within the saltwater of the water phase within the vessel, which is typically in the lower half or portion of the vessel. Exemplary placement includes the anode assembly in the lower portion of the vessel and the sensor assembly or monitor near or in the fire tube. The inventor has found that the metal bond between the anode assembly and the wall of the vessel provides superior performance or protection compared to prior art methods of cathodic protection. The present invention may provide a higher initial output and a longer lifespan (of the anode) with a higher output during the lifespan. In particular, the use of zinc has been found to provide great protection compared to prior art methods and other materials. However, the use of zinc is not a limitation on the present invention.

### BRIEF DESCRIPTION OF THE DRAWINGS

The invention may be more readily understood by referring to the accompanying drawings in which:

FIG. 1 is a perspective view of a heater treater with the vessel in cross-section in accordance with a preferred embodiment of the present invention;

FIG. 2 is a perspective view of a heater treater vessel that includes a flange connection for a consumable assembly;

FIG. 3 is a cross-section of the heater treater of FIG. 1 showing the anode assembly on a wall of the vessel;

FIG. 4 is detail view of a portion of the interior of the vessel showing the anode assembly and the sensor assembly;

FIG. 5 is another cross-section of the heater treater of FIG. 1 showing the anode assembly on a wall of the vessel;

FIG. 6 is an elevational view of the consumable assembly;

FIG. 7 is a perspective of the consumable assembly showing the anode assembly exploded from the anode receiver assembly;

FIG. 8 is a perspective view of the consumable assembly outside the vessel with a victaulic fitting;

FIG. 9 is a perspective view of the receiver assembly portion for a flange fitting;

FIG. 10 is a cross-sectional view of the consumable assembly in a sleeve of the vessel;

FIG. 11 is a perspective view of the sensor assembly;

FIG. 12 is an exploded view of the sensor assembly;

FIG. 13 is a perspective view of the portion of the sensor assembly that is located outside of the vessel; and

FIG. 14 is a perspective view of the sensor assembly from outside vessel and in a sleeve or tube.

Like numerals refer to like parts throughout the several views of the drawings.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments. If a component is not shown in a drawing then this provides support for a negative limitation in the claims stating that that component is “not” present. However, the above statement is not limiting and in another embodiment, the missing component can be included in a claimed embodiment.

Reference in this specification to “one embodiment,” “an embodiment,” “a preferred embodiment” or any other phrase mentioning the word “embodiment” means that a particular feature, structure, or characteristic described in connection with the embodiment is included in at least one embodiment of the-disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional. Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

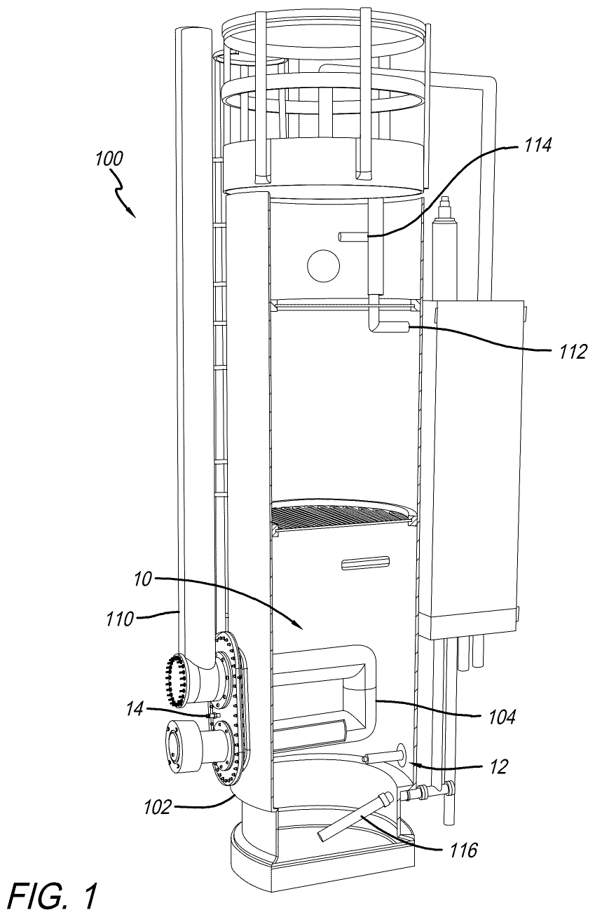

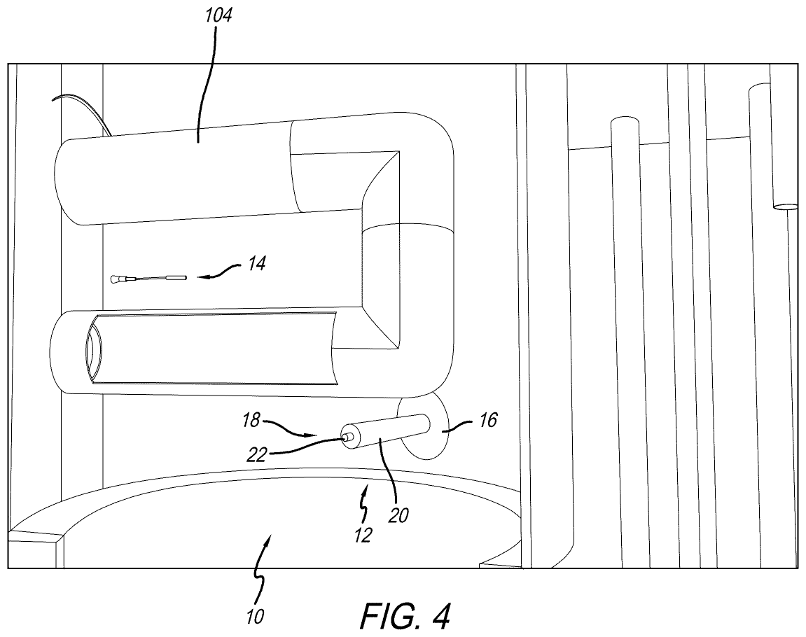

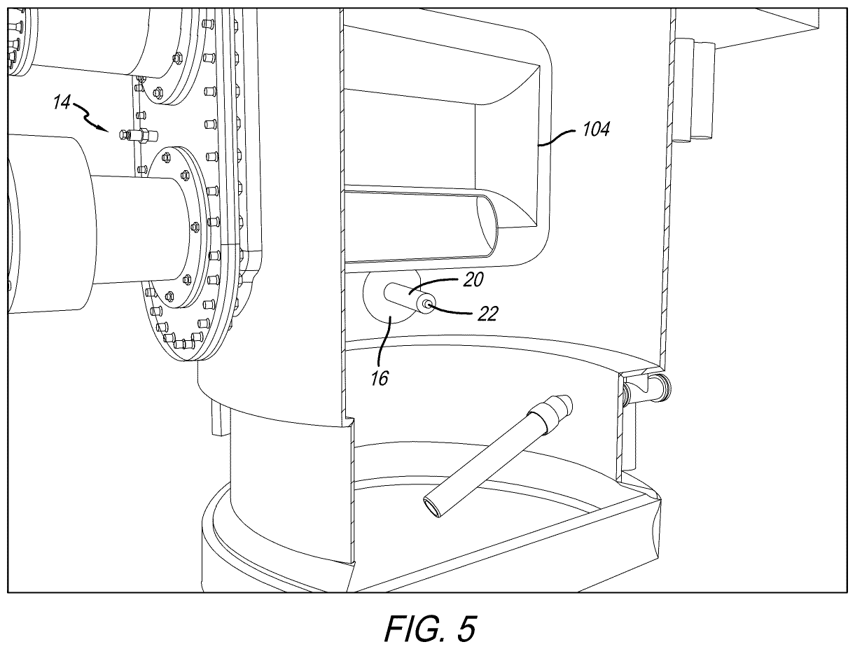

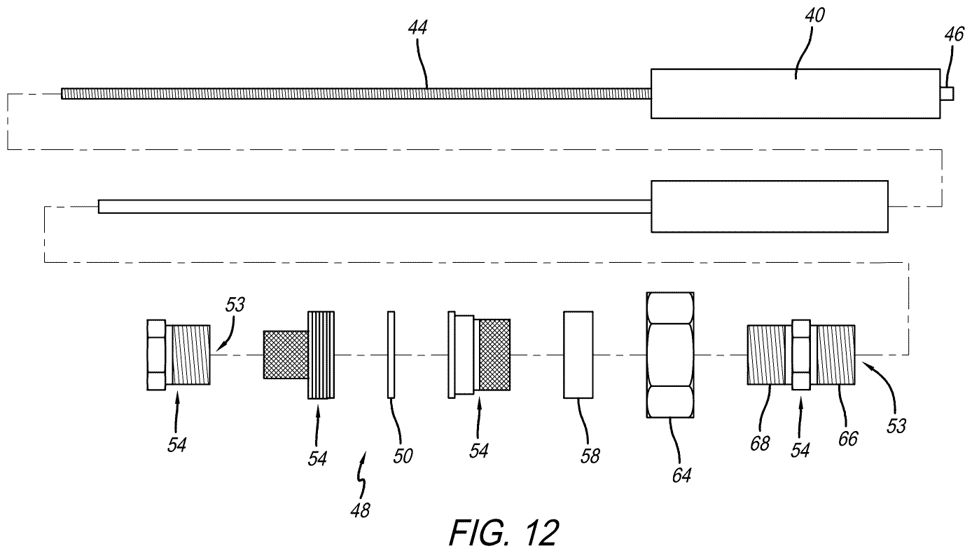

Referring now to the drawings, which are for purposes of illustrating the present invention and not for purposes of limiting the same, FIGS. 1-14 show devices and components (and related methods) therein in accordance with preferred embodiments of a cathodic protection system and method for oil and gas heater treater vessels.

FIG. 1 is a perspective cutout drawing of a vertically oriented heater treater vessel 100 in accordance with a preferred embodiment of the present invention. The vessel 100 includes a housing 102, a fire tube 104, a flange fitting 106, an exhaust 110 and a cathodic protection system 10 that generally includes a consumable assembly 12 and a sensor assembly 14. One of ordinary skill in the art would understand that a heater treater vessel 100 includes a number of other components and features to treat crude oil emulsions. The treatment preferably applies heat from the heating element (e.g., the fire tube 104) causing separation of the emulsion into oil, gas, and water phases. The treatment also preferably includes an inlet 112 and an inlet diverter 114 that separates gas from the crude oil emulsions.

The housing 102 is composed of steel, on both the interior and exterior of the housing. Preferably, crude oil emissions are pumped into the vessel 100 through an inlet (not shown in FIG. 1) and comprise oil, gas, and water (e.g., saltwater), that accelerates corrosive activity on the interior of the housing 102. Free water (i.e., free from the crude oil emulsions) drains to the bottom of the tank from a drain 116. The crude oil emulsions are typically pumped into the vessel 100 at a high velocity, creating electrical current. Without intervention, the interior of the housing 102 corrodes (e.g., rust) as a result to being exposed to crude oil emissions pumped at high velocity.

The fire tube 104 is preferably a metallic structure configured to heat the crude oil emulsions to separate oil from water. Treating temperatures can range from 98.6-158 F, depending on the crude oil's viscosity. Based on the densities of oil and water, when the crude oil emulsions are heated, the oil rises and provides an oil phase that is above the water phase. In practice, the heating process reduces the viscosity of the oil, helping break down the emulsion and separates the oil solids and free water. The heating of crude oil emulsions exacerbates the accumulation of electrical current that further corrodes the interior steel of the housing 102. The free water is drained out of the bottom of the vessel 100 through the drain 116. The oil solids, having a lower density than the free water, rises above the free water as a result of the treatment. Other heating elements are possible without departing from the scope of the present invention. Preferably the fire tube 104 is submerged in the water phase of the vessel 100. The fire tube 104 in an embodiment is a u-shaped tube in which the lower portion of the fire tube 104 includes the heating element (e.g., fire to heat the crude oil emulsions) and the upper portion is coupled to an exhaust 110 to allow the gasses emitted from the fire tube 104 to exhaust to the outside of the vessel 100.

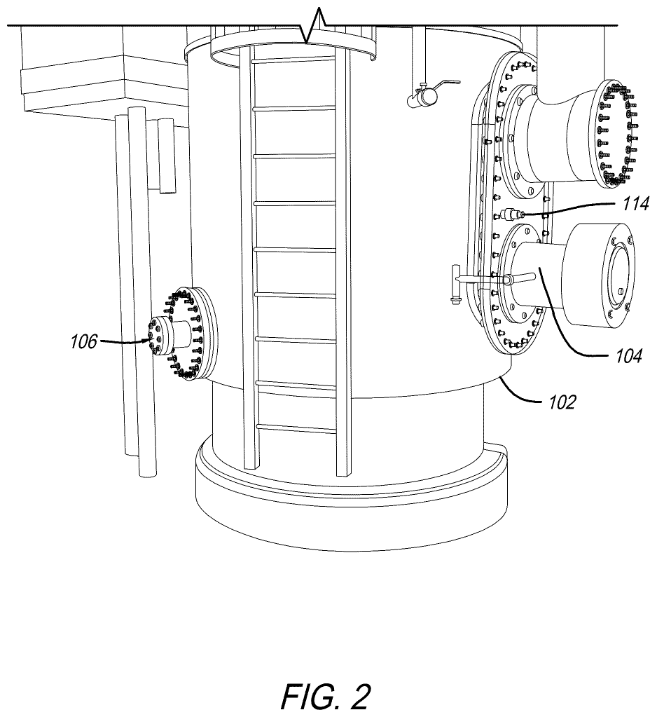

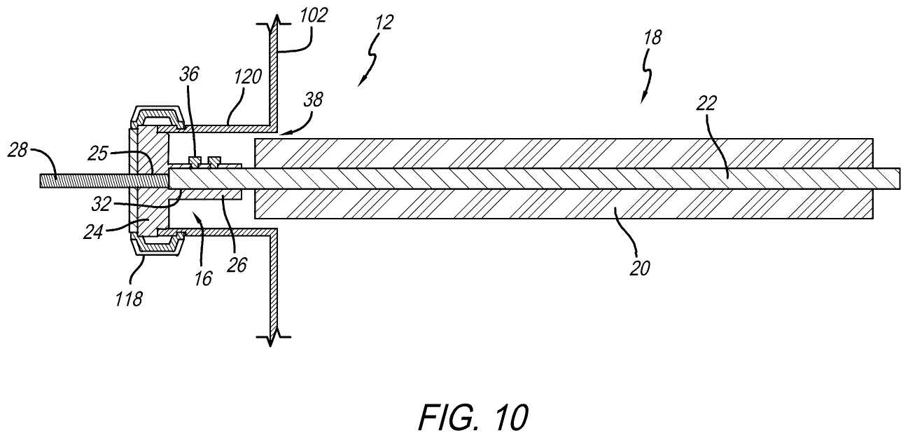

FIG. 2 is a drawing depicting an exterior of the vessel 100 in accordance with a preferred embodiment of the present invention. FIG. 2 shows the flange fitting 106 on the exterior of the vessel 100. The flange fitting 106 may also be a victaulic fitting (see FIG. 10) and is configured to allow insertion of apparatus into the interior of the vessel 100. For example, as described further below, the fitting 106 is configured to permit the coupling of the anode receiver assembly 16 of the cathodic protection system 10 to the housing 102 so that the anode assembly 18 extends into the interior of the vessel 100.

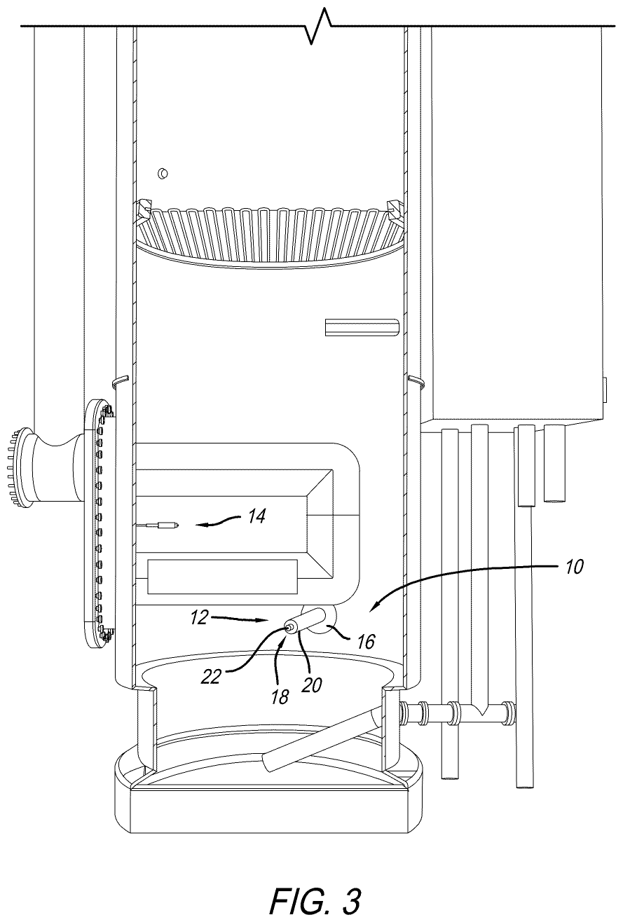

FIGS. 3-5 show the interior of the vessel 100 and include the cathode protection system 10, including the consumable assembly 12, which includes the anode receiver assembly 16 and anode assembly 18, and the sensor assembly 14. The anode assembly 18 preferably includes a metal anode 20 comprising a metal weaker than the steel of the housing 102, and a metal rod 22. For example, the metal anode 20 is comprised of aluminum. In other embodiments, the metal anode may be silver or zinc. The metal anode 20 is configured to provide an electrical circuit within the water phase of the vessel 100 and reduce or eliminate the corrosion of the interior of the housing 102.

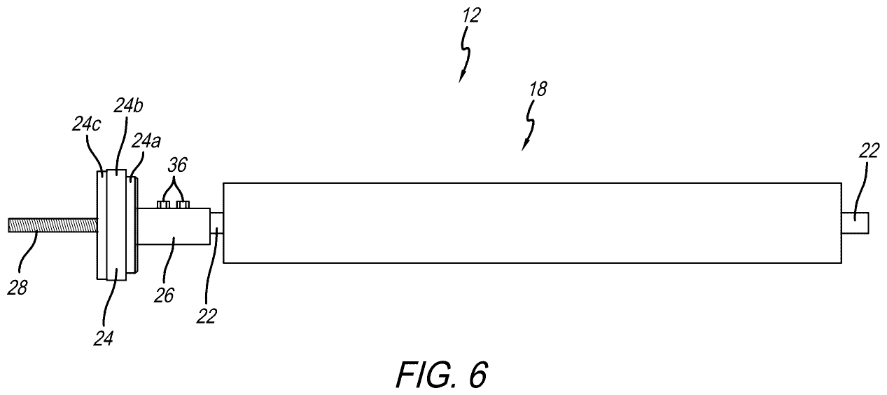

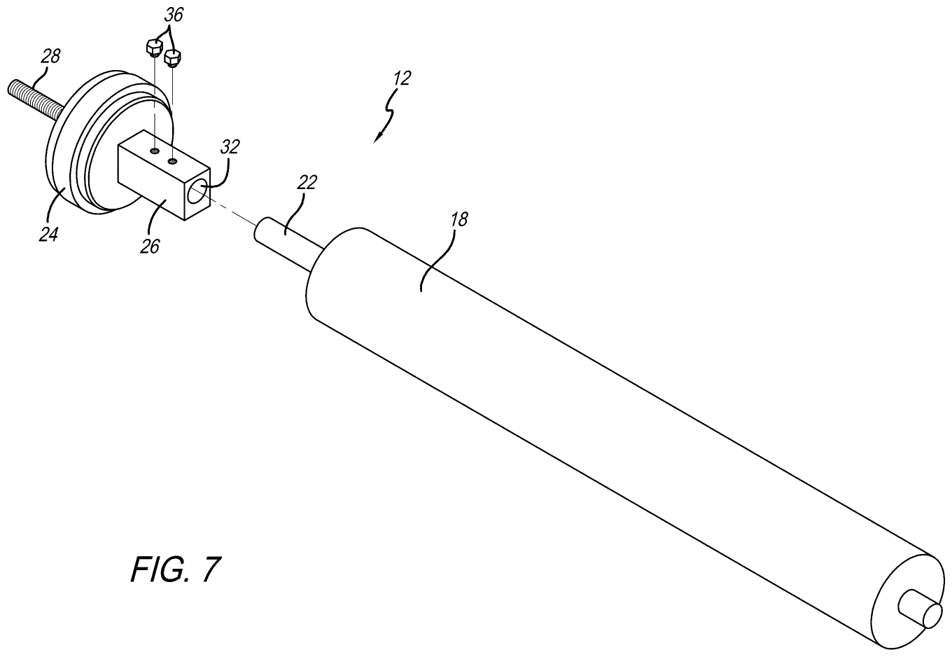

FIGS. 6 and 7 show the consumable assembly 12 with the anode assembly 18 and anode receiver assembly 16. The anode receiver assembly 16 preferably includes a ground member 24 and a receiver portion 26. The anode receiver assembly 16, and, preferably the ground member 24 provides a self-grounding mechanism by the metal touching the metal or steel of the vessel wall or housing. This may eliminate the need to separately run ground wires to attach to the end of the metal rod 22 of the anode assembly 18. In a preferred embodiment, the receiver portion 26 includes a receiver opening 32 defined therein. In a preferred embodiment, the receiver portion 26 includes at least one securing opening 34 defined therein (two are shown in the figures). The securing openings 34 may extend in a direction generally perpendicular to the receiver opening 32 and the axis thereof. A threaded fastener 36 may be received in the securing opening 34 and may be movable to a securing position, where it is in contact with the metal rod 22 of the anode assembly 18 to secure the anode assembly 18 in position and a non-contact position, where the metal rod 22 can be moved in and out of the receiver opening 32.

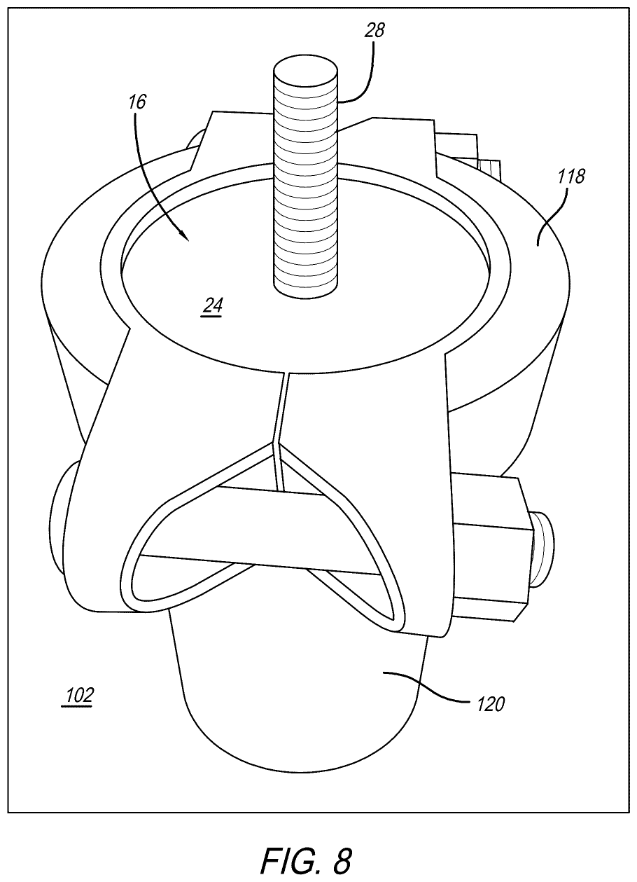

As shown in FIG. 8, the anode receiver assembly shown in FIGS. 6-7 is configured to be used with a victaulic fitting. The anode receiver assembly 16 may include a threaded rod 28 secured to and extending from the ground member 24. In a preferred embodiment, the ground member 24 may include a threaded opening 25 therein that receives the threaded rod 28. As shown in FIG. 8, the victaulic fitting 118 surrounds and secures the ground member 24 and helps provide the metal to metal contact for grounding purposes. The threaded rod 28 extends outwardly and away from the victaulic fitting 118. In this embodiment, the anode receiver assembly 16 is at least partially housed or received in a sleeve 120 built into or secured to the wall or housing of the vessel. In a retrofit situation, many heater treater vessels have sleeves or tube already included therewith. The ground member 24 may include different or first, second and third different diameter portions 24a, 24b and 24c, that may be used to help secure the anode receiver assembly in place and to help provide the electrical connection for grounding purposes.

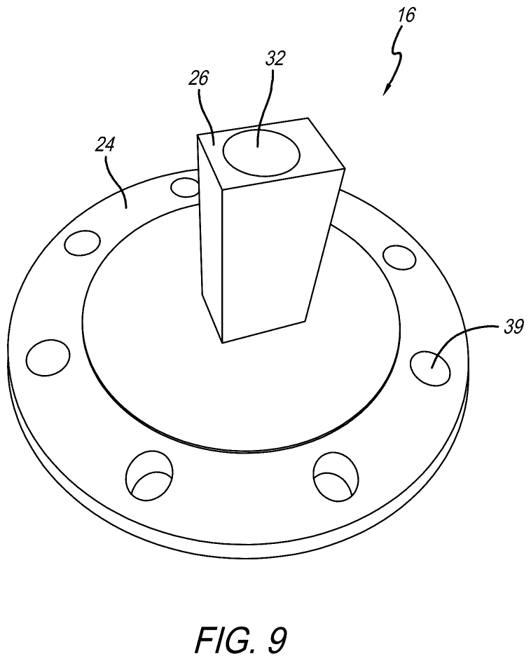

FIG. 9 shows an anode receiver assembly 16 that is configured to be used with a flange fitting 106. In this embodiment, the threaded rod is omitted and the ground member is sized to fit in a flange fitting 106 that may be part of a heater treater vessel being retrofitted. The ground member 24 may have a series of openings 39 defined therein to allow bolts to pass therethrough for connection purposes.

FIG. 10 shows the consumable assembly 12 secured using a victaulic fitting 118 in a sleeve 120 on the housing 102. It will be appreciated that the consumable assembly 12 (and the anode receiver assembly 16 thereof) may be secured to or associated with any opening, hole or port in the vessel 100 or the housing 102 thereof. An opening, sleeve, hole or any component that communicates the vessel interior with the exterior thereof may be referred to herein as a port. A port may be an existing sleeve, opening or the like in the housing of the vessel or it may be drilled or otherwise formed specifically for use in the scope of the present invention. As shown in FIG. 10, the consumable assembly 12 is coupled to or secured in or extends through the anode port 38. This allows the anode 20 to be positioned in the water phase during use. The victaulic fitting, flange fitting or other fitting allows the consumable assembly 12 to be removed and the anode assembly 18 replaced. The anode assembly 18 is decoupled or removed from the anode receiver assembly 16, a new anode assembly 18 is secured to or coupled with the anode receiver assembly 16 and then the consumable assembly 12 (with the new anode assembly) is inserted through the anode port and secured using the fitting or other securing member.

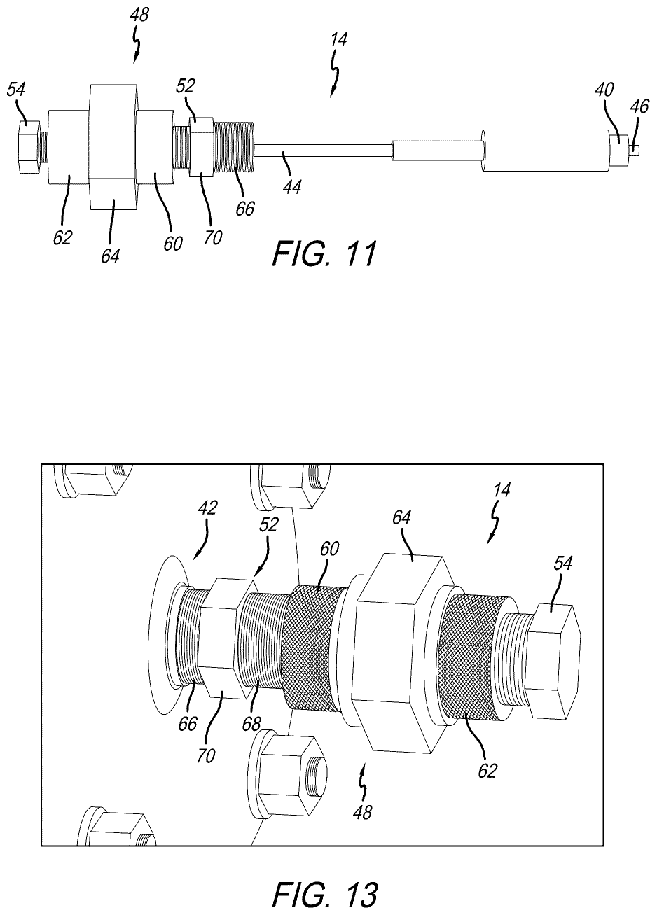

FIGS. 11-14 are directed to the sensor assembly 14, which preferably includes an electrode 40 that, in use, extends into and is positioned in the water phase of the vessel 100. The electrode may be made of zinc and may be used to test a magnitude of the electrical current within the water phase of the vessel 100. The sensor assembly 14 is coupled to a sensor port 42. Generally, the sensor assembly 14 may include an extension shaft 44, a sensing point 46 at the distal end of the extension shaft 44, an isolation unit 48 configured to electrically isolate the sensor assembly from the housing 102, and the electrode 40.

The isolation unit 48 may include a number of components that are received on the extension shaft 44, including an isolation member 50 that provides the electrical isolation. This prevents the sensor assembly and the components thereof from being grounded. This is important because if the sensor assembly was grounded the electrode would become an anode and would be consumed. The isolation member 50 may be a rubber gasket or the like or any component that provides isolation from the vessel (and prevents metal to metal contact between the vessel and the sensor assembly). Other components may include a first contact member 52, a second contact member 54 and a union fitting 56. The union fitting 56 may include a rubber spacer 58, a first threaded part 60, a second threaded part 62, and a tightening nut 64. The components of the isolation unit 48 work together to maintain the isolation member (e.g., rubber gasket) positioned so that it provides electrical isolation from the vessel housing.

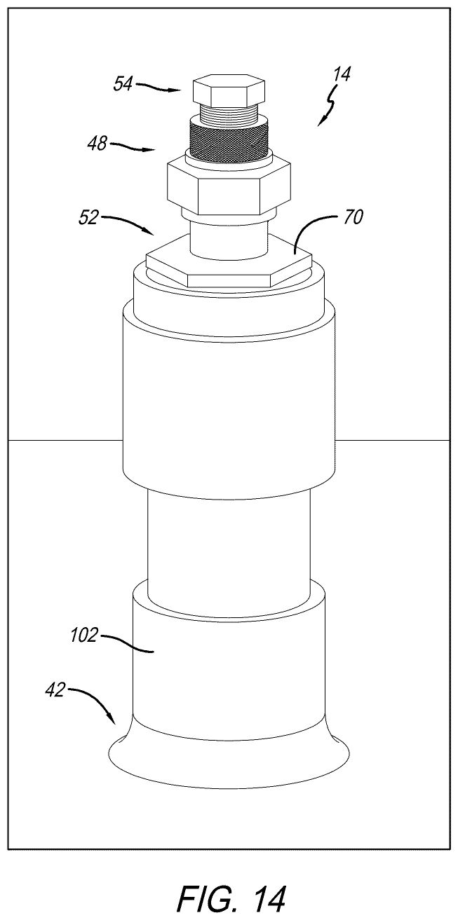

The first contact member 52 may include external threads so that it can be coupled to the housing. For example, the first contact member 52 may be threadedly connected in a sleeve 120, port or other opening in the housing 102, as shown in FIG. 14. The first contact member 52 may include first and second threaded portions 66 and 68 separated by a hex fitting 70. The first threaded portion 66 may be used to thread to the vessel and the second threaded portion 68 is used to connect to the second threaded part 62. The first threaded part 60 also preferably includes internal threads for connection to the second contact member 54.

In a preferred embodiment, the extension shaft 44 is externally threaded and a number of the components discussed above (such as the first and second contact members 52 and 54) may be internally threaded (or included threaded openings 53 axially therethrough) so that they can be threaded on and received on the extension shaft 44. The sensor assembly 14 may also include a rubber sleeve 72 that is received on the extension shaft 44 and electrode 40.

In use, the sensing point 46 is submerged in the water phase of the vessel 100. The consumable assembly 12 is grounded and thus electrically connected to the housing and the sensor assembly 14 is normally not grounded and is thus not electrically connected to the housing. Therefore, during normal use of the heater treater, there is a current that flows within the salt water phase that is degrading or consuming the material of the anode 20, which is part of the cathodic protection system 10 (protecting the housing). When desired (which may be at predetermined time intervals), the sensor assembly 14 can be used to check the status of the anode 20. The sensing point 46 is configured to measure a voltage between the electrode 40 and the anode 20. When the measured voltage exceeds a predetermined threshold, the anode assembly 18 is replaced. When using the sensor assembly 14 to check or determine the status of the anode, an electrical connection between the test point on the zinc side of the electrode (the sensing point 46) and the exterior of the vessel is created. This may be done by placing a first probe of the voltmeter on a metal component on a first or electrode side of the isolation member 50 (e.g., toward the inside of the vessel), such as on the first contact member 52, and a second probe of the voltmeter on a metal component on a second or ground side of the isolation member 50 (e.g., toward the outside of the vessel), such as on the second contact member 54. This essentially closes the circuit and allows the voltage to be measured across the first and second contact members (or other metal components on opposite sides of the isolation member. During the time that the voltage measurement is being taken, the sensing point (which may be any point along the zinc electrode and the steel extension member within the salt water phase) and the second contact member are electrically connected and the zinc electrode becomes an anode. In another embodiment, wires may be permanently connected to the first and second contact members or the like. Furthermore, the zinc becomes a reference metal for determining whether the voltage exceeds the predetermined threshold or is within a predetermined range and reaches the point where the anode should be replaced. It will be appreciated that other metals may be used as an electrode and a reference metal. As the anode degrades over time, the current (which can be converted to a voltage) within the saltwater phase changes (e.g., from negative to positive and then further positive). It will be appreciated that the predetermined threshold is determined based on the reference metal and known measurements.

In a preferred embodiment of the present invention, functionality may be implemented as software executing on a server that is in connection, via a network, with other portions of the system, including databases and external services. The server comprises a computer device capable of receiving input commands, processing data, and outputting the results for the user. Preferably, the server consists of RAM (memory), hard disk, network, central processing unit (CPU). It will be understood and appreciated by those of skill in the art that the server could be replaced with, or augmented by, any number of other computer device types or processing units, including but not limited to a desktop computer, laptop computer, mobile or tablet device, or the like. Similarly, the hard disk could be replaced with any number of computer storage devices, including flash drives, removable media storage devices (CDs, DVDs, etc.), or the like.

The network can consist of any network type, including but not limited to a local area network (LAN), wide area network (WAN), and/or the internet. The server can consist of any computing device or combination thereof, including but not limited to the computing devices described herein, such as a desktop computer, laptop computer, mobile or tablet device, as well as storage devices that may be connected to the network, such as hard drives, flash drives, removable media storage devices, or the like.

The storage devices (e.g., hard disk, another server, a NAS, or other devices known to persons of ordinary skill in the art), are intended to be nonvolatile, computer readable storage media to provide storage of computer-executable instructions, data structures, program modules, and other data for the mobile app, which are executed by CPU/processor (or the corresponding processor of such other components). The various components of the present invention, are stored or recorded on a hard disk or other like storage devices described above, which may be accessed and utilized by a web browser, mobile app, the server (over the network), or any of the peripheral devices described herein. One or more of the modules or steps of the present invention also may be stored or recorded on the server, and transmitted over the network, to be accessed and utilized by a web browser, a mobile app, or any other computing device that may be connected to one or more of the web browser, mobile app, the network, and/or the server.

References to a “database” or to “database table” are intended to encompass any system for storing data and any data structures therein, including relational database management systems and any tables therein, non-relational database management systems, document-oriented databases, NoSQL databases, or any other system for storing data.

Software and web or internet implementations of the present invention could be accomplished with standard programming techniques with logic to accomplish the various steps of the present invention described herein. It should also be noted that the terms “component,” “module,” or “step,” as may be used herein, are intended to encompass implementations using one or more lines of software code, macro instructions, hardware implementations, and/or equipment for receiving manual inputs, as will be well understood and appreciated by those of ordinary skill in the art. Such software code, modules, or elements may be implemented with any programming or scripting language such as C, C++, C#, Java, Cobol, assembler, PERL, Python, PHP, or the like, or macros using Excel or other similar or related applications with various algorithms being implemented with any combination of data structures, objects, processes, routines or other programming elements.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges.

Although the operations of any method(s) disclosed or described herein either explicitly or implicitly are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

The teachings of the disclosure provided herein can be applied to other systems, not necessarily the system described above. The elements and acts of the various embodiments described above can be combined to provide further embodiments. Any measurements or dimensions described or used herein are merely exemplary and not a limitation on the present invention. Other measurements or dimensions are within the scope of the invention.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will include the words “means for”). Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A cathodic protection system for a heater treater vessel, the cathodic protection system comprising:
the heater treater vessel, wherein the heater treater vessel includes a housing, a heating element, and an anode port, wherein the vessel is configured to be supplied with crude oil emulsions for treatment by the vessel, wherein the treatment comprises applying heat from the heating element causing separation of the emulsion into oil, gas, and water phases, such that electrical current is generated within the water phase of the vessel, and
a consumable assembly removably coupled to the anode port,
wherein the consumable assembly includes an anode assembly and an anode receiver assembly, wherein the anode assembly includes a metal rod and an anode comprised of a weaker metal than the metal rod, wherein the anode is in contact with the metal rod,
wherein the anode receiver assembly includes a receiver portion and a ground member, wherein the receiver portion is electrically connected to the ground member, wherein the metal rod of the anode assembly is received in and electrically connected to the receiver portion, wherein the ground member is electrically connected to the housing to provide an electrical grounding point, wherein the metal rod and the anode are submerged within the water phase of the vessel to provide cathodic protection to the interior of the housing by completing an electrical circuit within the water phase of the vessel.

2. The cathodic protection system of claim 1 further comprising a sensor assembly coupled to a sensor port in the vessel, the sensor assembly comprising a sensing point, an extension shaft, an electrode on the extension shaft, an isolation unit configured to electrically isolate the sensor assembly from the housing, a first contact member positioned on an electrode side of the isolation unit and a second contact member positioned on a ground side of the isolation unit,
wherein the electrode and the sensing point are submerged in the water phase of the vessel, and wherein when a measured voltage between the electrode and the anode exceeds a predetermined threshold, the anode assembly is removed from the anode receiver assembly and replaced with a second anode assembly.

3. The cathodic protection system of claim 2 wherein the first contact member includes a threaded opening extending axially therethrough, and wherein the extension member is externally threaded and extends through the first contact member.

4. The cathodic protection system of claim 3 wherein the first contact member includes a first threaded portion that is connected to the sensor port.

5. The cathodic protection system of claim 1 wherein the receiver portion includes a receiver opening defined therein, wherein the metal rod of the anode assembly is received in the receiver opening.

6. The cathodic protection system of claim 5 wherein the receiver portion includes a securing opening defined therein and extending in a direction generally perpendicular to the receiver opening, wherein a threaded fastener is received in the securing opening and against the metal rod of the anode assembly, to secure the anode assembly in position.

7. The cathodic protection system of claim 2, wherein the electrode comprises zinc.

8. A method of cathodically protecting a heater treater vessel that includes a housing, the method comprising the steps of:
associating a consumable assembly with the housing, wherein the consumable assembly includes an anode assembly and an anode receiver assembly, wherein the anode assembly includes a metal rod and an anode comprised of a weaker metal than the metal rod, wherein the anode is in contact with the metal rod, wherein the anode receiver assembly includes a receiver portion and a ground member, wherein the receiver portion is electrically connected to the ground member, wherein the metal rod of the anode assembly is received in and electrically connected to the receiver portion, wherein the ground member is electrically connected to the housing to provide an electrical grounding point, and wherein the metal rod and the anode are submerged within a water phase of the vessel,
associating a sensor assembly with the housing, wherein the sensor assembly includes an electrode submerged within the water phase of the vessel, and wherein the sensor assembly is electrically isolated from the housing, and
measuring a voltage between the electrode of the sensor assembly and the anode of the consumable assembly, wherein if the measured voltage exceeds a predetermined threshold, the anode assembly is removed from the anode receiver assembly and replaced with a second anode assembly.

9. The method of claim 8 wherein the electrode of the sensor assembly comprises zinc.

10. A consumable assembly for use in a cathodic protection system associated with a heater treater vessel, the consumable assembly comprising:
an anode receiver assembly that includes a receiver portion and a ground member, wherein the receiver portion is electrically connected to the ground member, and
an anode receiver assembly, wherein the anode assembly includes a metal rod and an anode comprised of a weaker metal than the metal rod, wherein the anode is in contact with the metal rod, wherein the metal rod of the anode assembly is received in and electrically connected to the receiver portion.

11. The consumable assembly of claim 10 wherein the ground member is configured to be secured in a victaulic fitting.

12. The consumable assembly of claim 11 wherein the ground member includes a threaded opening defined therein, wherein a threaded rod is received in the threaded opening, and wherein the threaded rod extends co-axially with the metal rod of the anode assembly.

13. The consumable assembly of claim 10 wherein the ground member is configured to be secured in a flange fitting.

14. The consumable assembly of claim 10 wherein the receiver portion includes a receiver opening defined therein, wherein the metal rod of the anode assembly is received in the receiver opening.

15. The consumable assembly of claim 13 wherein the receiver portion includes a securing opening defined therein and extending in a direction generally perpendicular to the receiver opening, wherein a threaded fastener is received in the securing opening and against the metal rod of the anode assembly, to secure the anode assembly in position.
